(19) United States
(12) Patent Application Publication
(10) Pub. No.: US 2011/0086328 A1
(43) Pub. Date: Apr. 14, 2011

(54) METHOD AND APPARATUS FOR PRODUCING A DENTAL IMPLANT

(76) Inventor: Todd Wedeking, Lafayette, CA (US)

(21) Appl. No.: 12/899,259

(22) Filed: Oct. 6, 2010

Related U.S. Application Data
(60) Provisional application No. 61/250,419, filed on Oct. 9, 2009.

(51) Int. Cl. A61C 8/00; A61C 11/00; G06F 17/50; G06F 19/00

(52) U.S. Cl. 433/174; 433/175; 433/213; 703/1; 700/159; 700/117

(57) ABSTRACT

A dental implant may be produced having an organic shape corresponding to the root shape of a tooth the implant replaces. Following atraumatic extraction of the tooth, the implant may be inserted and subsequently graft to the root socket. Features of the implant maximize compatibility and positive outcomes.

### CROSS-REFERENCE TO RELATED APPLICATIONS

The present application claims priority benefit from copending U.S. Provisional Patent Application Ser. No. 61/250,419; entitled “METHOD AND APPARATUS FOR PRODUCING A DENTAL IMPLANT”; filed Oct. 9, 2009; which is incorporated by reference herein in its entirety.

### BACKGROUND

In the prior art, dental implants have typically included cylindrical, conical, volume parabolic and/or other stock shapes configured for insertion into a patient's bone structure. Typically, such stock shapes are substantially rotationally or helically symmetric, and may include self-threading features to ease implantation. Subsequent osseous integration occurs over a period of time wherein the implant becomes securely coupled to the bone. Following osseointegration, a permanent crown is attached to the implant, directly or via an attachable abutment.

Unfortunately, the use of such standardized shapes may generally require a relatively large amount of bone structural modification such as an osteotomy to build a socket into which the implant will fit.

### SUMMARY

According to an embodiment, a method for providing a custom dental implant includes capturing an in-vivo image of the root of a tooth, the periodontal ligament of the tooth, the boney socket of the tooth, or alternatively of an impression material substantially filling a volume previously occupied by the root of the tooth. An image or data corresponding to the image from the in vivo imager may then be used to drive an implant fabricator to fabricate an implant that corresponds the root morphology of the natural tooth that the implant replaces.

According to an embodiment, a system for preparing a custom dental implant may include an in-vivo imager that uses a penetrating short-wavelength (e.g., X-ray) illumination source and short-wavelength detector configured to measure the response of the illumination energy to the morphology of the root of a tooth and surrounding tissues. The in vivo imager may advantageously include a computed tomography (CT) scanner.

According to an embodiment, a system for preparing a custom dental implant may include an in-vivo imager that uses magnetic resonance imaging (MRI).

According to embodiments, data may be received from the in vivo imager by an image processor. The image processor may determine a surface substantially corresponding to the surface of the root of the tooth, the periodontal ligament (PDL), the boney socket of the tooth, or alternatively of an impression material substantially filling a volume previously occupied by the root of the tooth. A core design includes a computer model that substantially corresponds to the shape of the natural root of the tooth.

According to embodiments, core design data may be received by a computer-aided design (CAD) module. The CAD module may modify the core design to include features and/or shapes not present in the natural root of the tooth. The CAD module may be configured to receive data from the image processor module and modify the data to change the structure of a dental implant to include shape features configured to provide advantages, the shape features not being present in the natural tooth morphology. The CAD module may be fully automatic, manually controlled, or a combination thereof.

According to embodiments, a visible imager may capture an image of the visible portion of a tooth and/or surrounding teeth. According to embodiments, the visible image and the root image may be combined by the image processor, the CAD module, or another module. For example, the visible image and the root image may be combined to produce an implant that is indexed to the proper position in the patient's mouth, takes into account soft tissue position, corrects for an orthodontic condition, takes into account implant insertion path, or provide other modification, enhanced accuracy, or enhanced precision.

According to embodiments, a data conversion apparatus may include a computer configured to receive an image from the in vivo imager and optionally the visible imager, and convert the image to data corresponding to a system and/or implant fabrication instructions. According to an embodiment, a data conversion apparatus for producing an electronic model for a dental implant may include an interface to receive data from an in vivo root imager and a data conversion module configured to convert the received data into a data file suitable for modification and/or manipulation.

According to embodiments, an implant may be fabricated by a suitable fabrication technique. For example a micro-machining system (e.g., a CNC milling system), a sintering system, a rapid prototyping system (e.g., 3-D printing or electron-beam melting), a casting system, and/or other systems may be used singly or in combination to produce an implant, abutment, and/or other components associated with the implant.

According to embodiments, a kit for placing the implant may be provided to a dentist, oral surgeon, or other professional. The kit may include one or more of the implant, a finger screw for placing the implant, a cap for protecting a placed implant, an aliquot of sealer for sealing gaps and/or setting the implant or helping improve implant stability, an aliquot of anti-inflammatory and/or antibiotic medicament, a calibrated tool such as a burr for conditioning the bone surface, one or more prints showing the in vivo image and/or visible image, an elastically deformable model of the implant to aid in placing the implant, a clearance indication dye to aid in placing the implant, a bite surface attachment for seating the implant, an abutment, and/or an abutment screw.

### BRIEF DESCRIPTION OF THE DRAWINGS

FIG. 1 is a flowchart illustrating a method for producing a data model for making a custom dental implant, according to an embodiment.

FIG. 2 is a side sectional view of a tooth including a root volume and neighboring teeth, according to an embodiment.

FIG. 3 is a flow chart illustrating a method for providing a custom dental implant and crown to a patient, according to an embodiment.

FIG. 4 is a simplified partial side sectional view of an assembled implant system after implantation, according to an embodiment.

FIG. 5 is a block diagram of a system configured to produce a data model for making a custom dental implant, according to an embodiment.

FIG. 6 is a diagram illustrating a tool configured to remove a section of cortical bone layer from a root socket, according to an embodiment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

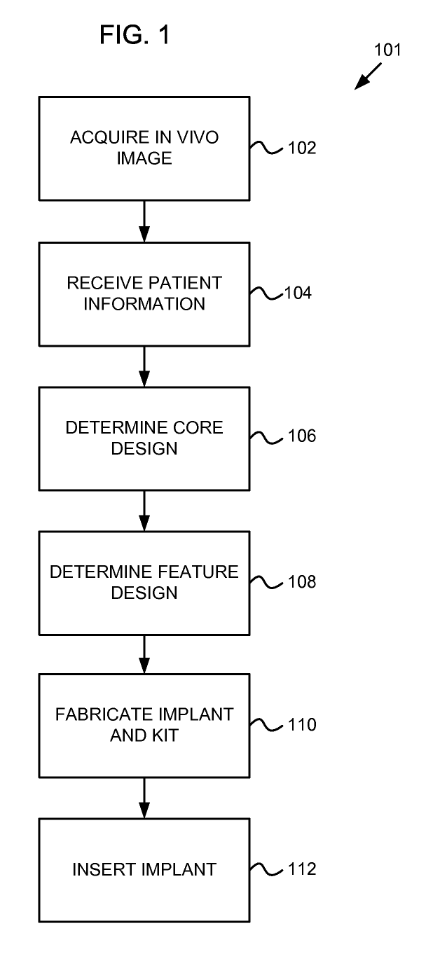

FIG. 1 is a flowchart illustrating a method 101 for producing a data model for making a custom dental implant, according to an embodiment. In step 102, one or more images including at least one in vivo image of tissues including and below the gum line of a patient is acquired. Such an image may be referred to as a root volume image.

For example, step 102 may include acquiring an image of at least a volume corresponding to a root of a tooth using illumination having a wavelength shorter than the visible portion of the electromagnetic spectrum. For example a wavelength shorter than the visible portion of the electromagnetic spectrum may include using X-ray illumination. Acquiring the image of the volume corresponding to a root of a tooth may include performing tomography such as computed tomography. Computed tomography may include computed axial tomography and/or cone beam computed axial tomography.

In another embodiment, step 102 may include acquiring an image of at least a volume corresponding to a root of a tooth using magnetic resonance imaging (MRI).

According to an embodiment, acquiring the image of the volume corresponding to a root of a tooth and surrounding structures (PDL and boney socket) may include receiving data corresponding to the image via a data interface. According to an embodiment, acquiring the image 102 of at least a volume corresponding to a root of a tooth may include acquiring the image of the root of the tooth and surrounding structures. According to an alternative embodiment, acquiring the image of at least a volume corresponding to a root of a tooth may include acquiring an image of an impression substantially filling a volume previously occupied by a root of a tooth.

According to an embodiment, step 102 may further include acquiring a visible image including at least an exposed volume corresponding to the tooth. For example, acquiring the visible image may include acquiring a visible image of the tooth and at least portions of neighboring teeth. Acquiring a visible image may include acquiring a visible image of an occlusion corresponding to the tooth.

According to an embodiment, acquiring a visible image may include acquiring a visible image registered to the root volume image acquired using illumination provided by radiation having a wavelength shorter than the visible portion of the electromagnetic spectrum. According to an embodiment acquiring a visible image may include acquiring a visible image bore-sighted to the root volume image acquired using illumination provided by radiation having a wavelength shorter than the visible portion of the electromagnetic spectrum.

Acquiring the image 102 may typically include acquiring an in situ image or an in vivo image. For purposes herein, these terms are considered equivalent and refer to acquiring an image of a root volume from the mouth of the patient. Such an image may, for example, include a voxel image. According to an embodiment, the imager may output a DICOM data file or other digital data file representative of the three-dimensional structure of a root volume of a tooth.

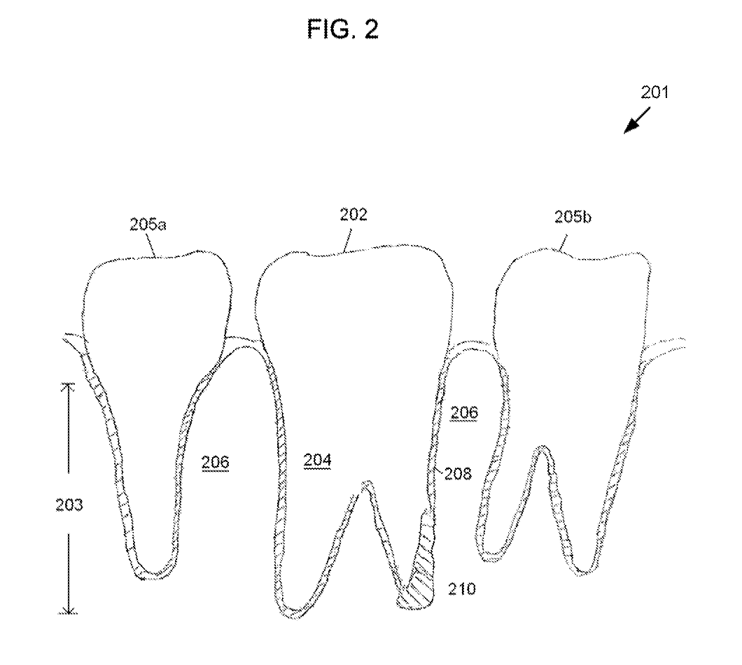

Referring to FIG. 2, the phrase root volume conveys scope corresponding to a root volume 203 including at least a portion of tooth 202 root 204. The root volume 203 further includes at least a portion of bone 206 encasing the root 204. Optionally, the root volume 203 may include at least portions of roots of neighboring teeth 205a, 205b.

Referring back to FIG. 1, proceeding to optional step 104, information about the patient may be input. As will be appreciated, patient information such as age, tooth designation, health, jaw strength, etc. may be helpful in interpreting image data and/or may be used to determine features to be included in a fabricated implant.

Proceeding to step 106, the at least one image acquired in step 102 is image processed to determine a core design. For example, step 106 may include image processing to determine a root socket shape that will result from future atraumatic extraction. A shape that closely corresponds to the root, PDL, or root socket shape is referred to as a core design. Patient information received in optional step 104 may further be used to aid in determining a core design from the image received in step 102.

For example, referring to FIG. 2, an image received in step 102 may include at least one slice that resembles FIG. 2. FIG. 2 is a side sectional diagram 201 of a tooth 202 including a root volume 203 and neighboring teeth 205a and 205b, according to an embodiment. The tooth 202 includes a root 204. The root volume 203 includes at least a portion of the root 204 and adjoining bone 206. A periodontal ligament (PDL) 208 may generally be a layer that occupies a volume between the root 204 and the bone 206. Moreover, one or more additional features 210, such as an abscess, may further occupy a portion of the root volume 203 and be in close proximity to the root 204.

Referring to FIG. 1, image processing performed in step106 may determine a core design that corresponds to the root 204, to the root 204 plus additional features 210, or to the root 204 plus additional features 210 plus PDL 208. The choice of whether to make the core design closely mimic the root 204, the root 204 plus additional features 210, or the root 204 plus additional features 210 plus PDL 208 may be made according to a likely atraumatic extraction volume and according to which convention is to be used in step 108. According to an illustrative embodiment, the core design is determined as the volume corresponding to the surface of the bone 206 adjoining the PDL 208, additional features 210 and/or root 204.

In young patients, the PDL 208 may be relatively thick, while in aged patients, the PDL may be very thin or substantially non-existent. Accordingly information about the patient received in step 104 may be used to inform the core design software module and help to determine the extent of the core design.

CT output files generally plot differences in tissue density and response to X-rays. In an aged patient, where the PDL is very thin or missing, it may not be easy to determine an interface between the bone 206 and PDL 208, or the PDL may be substantially missing.

Returning to FIG. 1, step 106 may include compensation for image artifacts. For example depending on the resolution of the root volume imager, the root volume image may include aliasing and/or pixelation. Scattering materials in and/or near an implant site may scatter X-rays and result in changes to the image. In step 106, the data describing surfaces may be smoothed and/or moved to compensate for such image artifacts.

Proceeding to step 108, the core model produced in step 106 may be modified. For example, step 108 may be performed by a computer-aided design or automatically by a computed design software module. For convenience, both embodiments will be referenced as being performed by a CAD module herein.

For example, step 108 may include modifying the received data such that the data also corresponds to one or more shapes not included in the acquired image or the core model. According to an embodiment, the data may be modified to fabricate a dental implant with increased surface area for bone integration, tissue attachment, and/or comfort, such as by including grooves, ridges, rings, notches, chevrons, custom 3-D patterns, and/or a roughened surface. Such features may help the inserted implant to remain substantially motionless relative to the bone during the osseointegration process, and/or may provide additional surface area for the re-grown bone to adhere to.

According to an embodiment, the data may be modified to add a tissue ring and an abutment interface. According to an embodiment, the data may be modified in step 108 for easier placement of a dental implant. For example, it may be desirable to include one or more index features configured to align with corresponding features on an appliance coupled to adjoining teeth. Such index features may help a practitioner precisely place the fabricated implant. Additionally or alternatively, one or more screw threads, such as for receiving a finger screw may be added. Typically finger screws are used to handle the implant during placement. Step 108 may include adding a mark for placement of a cylindrical hole, or including a cylindrical hole in the implant configured for tapping with threads or to receive a self-tapping finger screw. (Threads not included in the model may be formed during a machining process in the implant, such as by a machining process performed on a near net shape.)

According to an embodiment, step 108 may include modifying the received data to add an abutment interface. Typically, an implant may include a top surface configured to receive an abutment. The top surface may further include one or more registration features configured to control translation and rotation of an installed abutment relative to the implant such as an internal hexagonal shape or external hexagonal male figure component. The top surface and registration feature may provide the abutment interface. The abutment interface, in step 108, may be positioned spatially relative to the root socket, the bone adjoining the root socket, the neighboring teeth, and/or the gum surface. Such positioning may determine the depth of a subsequently applied crown and, at least in part, determine aesthetics of a crown attached to the implant.

Moreover, in step 108, an abutment may be selected or designed for coupling to the implant. To attach a crown to the implant, an abutment is typically placed upon the implant. According to an embodiment, the implant may include an integral abutment. However, to avoid stress and potential movement between the movement and the bone during osseointegration, it may be preferable to make the abutment separately attachable. Such an arrangement may allow a low relief temporary cap to be placed on the implant during osseointegration; the low relief cap may be resistant to transmitting stress to the healing implant. One reason for such resistance may include reduced moment arm above the gum line against which food, a patient's tongue, or other objects could press.

Because of the variation of tooth sizes, it is desirable to provide an abutment having a size, shape, and placement tailored to the particular tooth being replaced by the implant. Step 108 may include selecting one from a plurality of stock abutment configurations for a given implant. Alternatively, step 108 may include designing a custom abutment configured to couple to a particular implant.

According to an embodiment, step 108 may include modifying the core model to add a tissue ring. According to an embodiment, step 108 may include modifying the core model to provide greater stability or the implant. According to an embodiment, step 108 may include modifying the core model to replace displaced soft tissue.

According to an embodiment, step 108 may include modifying the core model to truncate or otherwise modify the implant morphology. For example, some tooth roots may include substantial curvature, tip elongation, or other features that would not be able to be inserted and/or fabricated. Additionally, design rules may be applied to avoid producing a model having a non-manufacturable or low yield shape. For example, minimum radius rules may be provided to account for preferred machine tool sizes. Step 108 may include truncating root tips or otherwise modifying the shape of the core model to avoid such curvatures, elongations, violation of design rules, or otherwise adapt the core model for best implant performance.

Optionally, data corresponding to the image acquired in step 102 may be reformatted. For example, the received data may correspond to computed tomography digital data. However determining the core design in step 106, determining the feature design in step 108, and/or fabricating an implant in step 110 may require putting the image data into a different format. Hence, step 102, 106, 108, and/or 110 may optionally include one or more data conversion steps.

Proceeding to step 110, data produced in step 108 is used to drive an implant fabrication machine. This may include, for example, transmitting the data to a dental implant production facility. Such data transmission may optionally include transmitting data corresponding to the acquired visible image. According to some embodiments, transmitting the data to a dental implant production facility may include transmitting the data to an external facility. According to other embodiments, transmitting the data to a dental implant production facility includes transmitting the image to an in-premises dental implant production machine.

According to respective embodiments, fabrication of the implant 110 may be carried out by additive (e.g., 3D printing, stereolithography, electron beam melting) or subtractive (e.g., CNC) methods. In some embodiments, selection of a fabrication method may substantially determine implant material selection. According to an embodiment, a fabrication step 110 may include fabricating a model, and subsequently using the model to form an implant (e.g., lost wax casting).

For example, an implant may be milled by a numerically controlled mill from Titanium 6 Aluminum 4 Vanadium (Ti6-4) rod or bar stock. It may be convenient to mill one or more stock shapes selected to fill an inventory of a shape library. For example, core model output may be sorted to select an entity maintained in a shape library. Such pre-selected shapes may be supplied from stock or on a build-to-order basis. Similarly, step 110 may include custom milling a unique shape not matched to a shape library. Such custom milling may be provided as a norm, or alternatively may be provided on an exception basis, such as when a core model falls outside a range of stock or stocked shapes.

According to an embodiment, a portion of an implant assembly, such as an abutment, may be made according to one or more of a range of stock shapes, and another portion of an implant assembly, such as a root shape, may be made according to a custom milling protocol.

According to an embodiment, a 3D printing or stereo lithography fabrication step 110 may include electron-beam cross-link initiation. E-beam initiated cross-linking may have an advantage over photon-initiated methods in that photoinitiators may be omitted from the implant material formulation. According to another embodiment, photoinitiators present in an implant material may be sequestered, isolated, or removed during or after cross-linking.

According to an embodiment, a fabrication step 110 may include a plurality of sequential or combined fabrication methods. For example, a lost wax model, 3D printing or stereolithography, or electron beam melting may be used to form a near net shape; and subsequent CNC milling may be used to form one or more features in the near net shape. Electron beam melting or 3D printing, stereolithography may be used to form a lost wax model, and the model used to cast an implant or a near net shape of an implant. Other combinations using known fabrication techniques or equivalent fabrication techniques may similarly be used. Typically, screw threads may be added using a milling process.

According to an embodiment, a fabrication step 110 may include addition of a coating such as a sealer coating and/or a hydroxyapatite (HA) coating configured for encourage osseointegration.

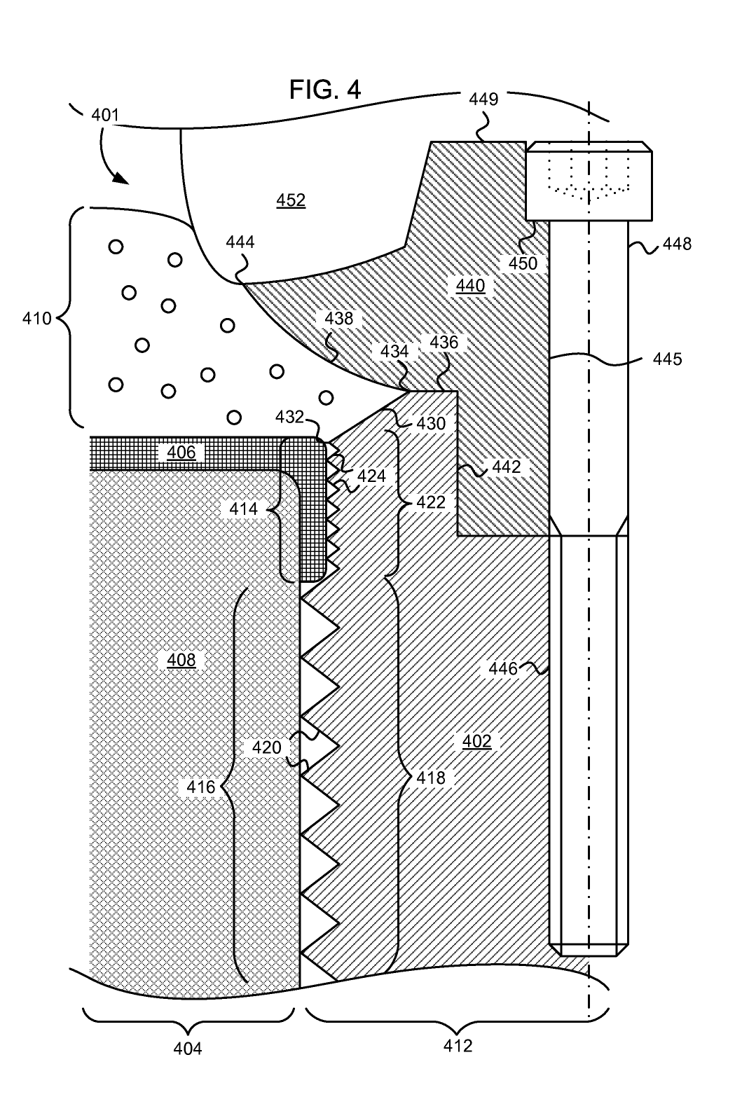

According to an embodiment, a fabrication process used in fabrication step 110 may be selected to produce an implant made from a desired material and/or having a desired surface texture. For example, a titanium 6-4 alloy (Ti6Al4V medical grade) may be preferred over stainless steel or cobalt chromium owing to its corrosion resistance. Some techniques such as electron beam melting may provide good surface porosity to encourage osseointegration. On the other hand, as may be appreciated from description associated with FIG. 4, below, it may be preferred to produce a variety of surface textures. In some techniques, such as electron beam melting (at least as of constructive reduction to practice), it may be challenging to produce the desired range of surface textures without some form of post-processing.

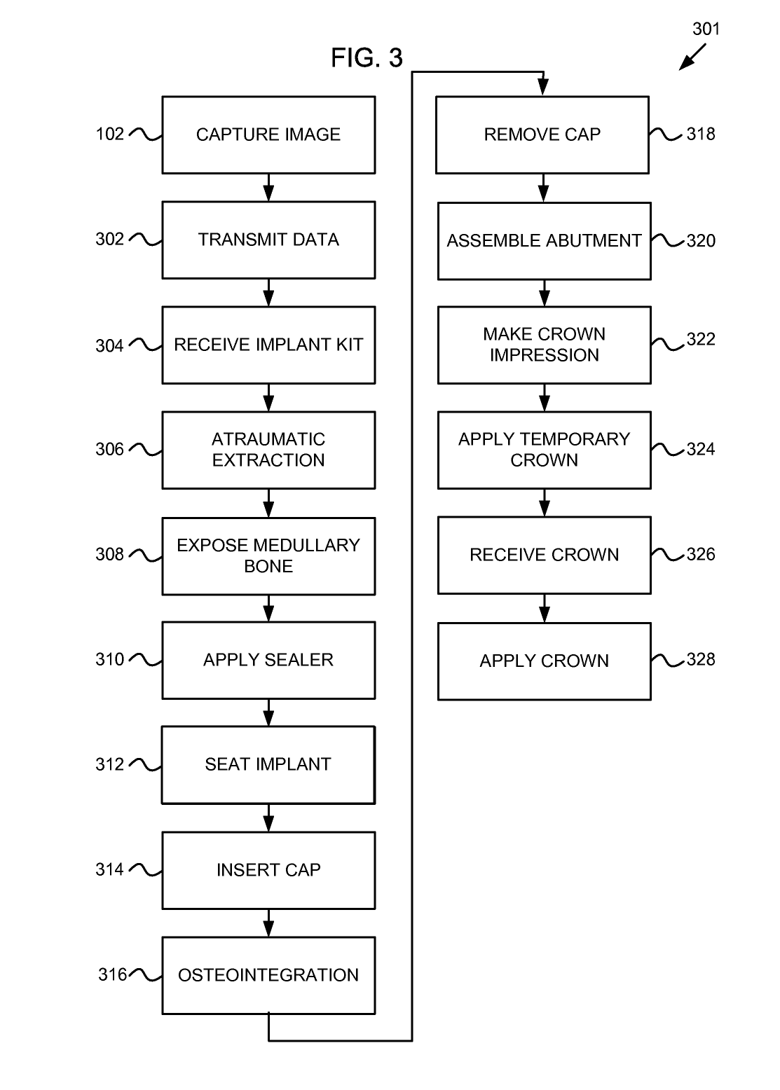

Proceeding to step 112, the implant is fitted to the patient. Implant fitting will be described in greater detail in conjunction with FIGS. 3 and 4.

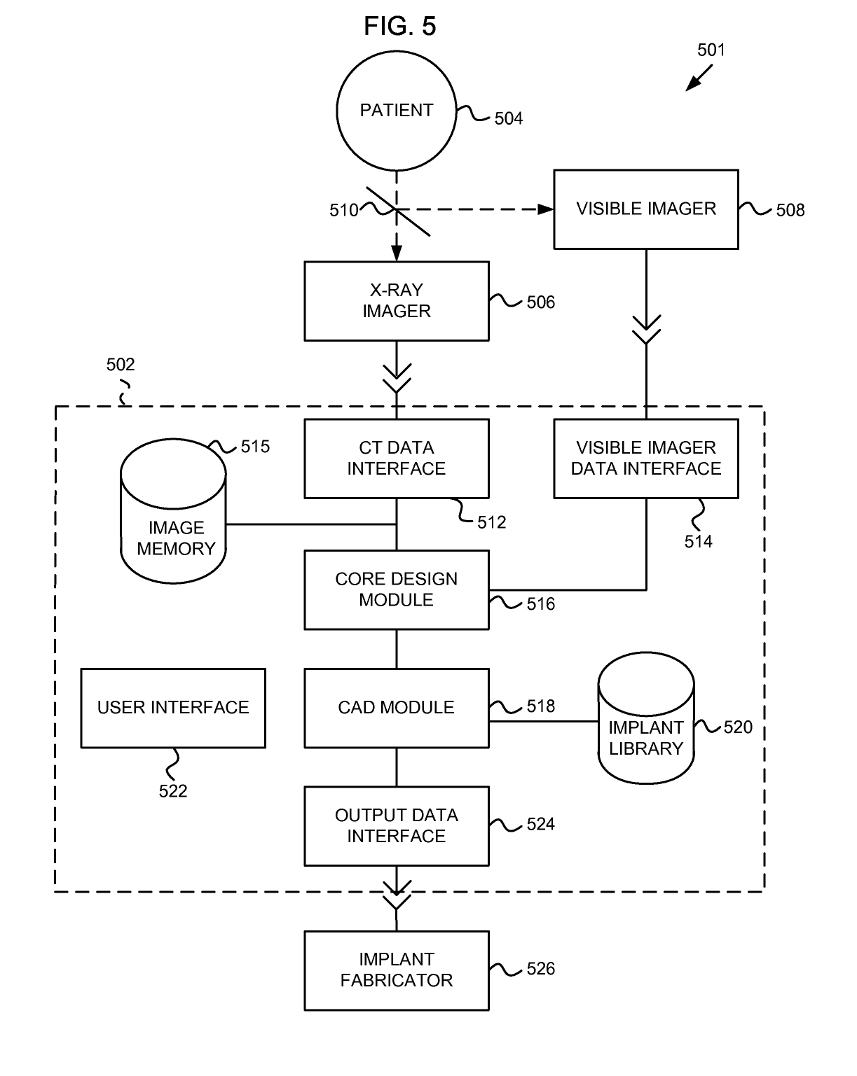

FIG. 3 is a flow chart illustrating a method 301 for providing a custom dental implant and crown to a patient, according to an embodiment. Starting with step 102, an in vivo image including at least the natural root of the tooth to be replaced is captured. As described above, step 102 may further include capturing an image of the visible tooth, surrounding teeth, and or soft tissues. Optionally the captured image may be a 3D image. Optionally, the captured image may be made by a process including one or more visible blue light LEDs. Alternatively, step 102 may include taking a conventional dental impression. Proceeding to step 302, data corresponding to the image captured in step 102 may be transmitted to an implant manufacturer. Processes and equipment used by the implant manufacturer are described in greater detail in conjunction with FIGS. 1 and 5. Constructions details of the implant are described in greater detail in conjunction with FIGS. 1, 2, and 4.

Proceeding to step 304, an implant kit is received by the practitioner. The kit may include one or more of the implant, an optional finger screw for placing the implant, a cap for protecting a placed implant, and/or an aliquot of sealer for setting the implant and/or filling in boney defects (e.g. acting as a bone graft material). For example, the sealer may include an aliquot of anti-inflammatory/antibiotic. A kit may alternatively or additionally include a calibrated tool such as a burr for conditioning the boney socket surface for implant placement and integration, one or more prints showing the in vivo image and/or visible image, an elastically deformable model of the implant to aid in placing the implant, a clearance indication dye to aid in placing the implant, a bite surface for seating the implant, an abutment, and/or an abutment screw.

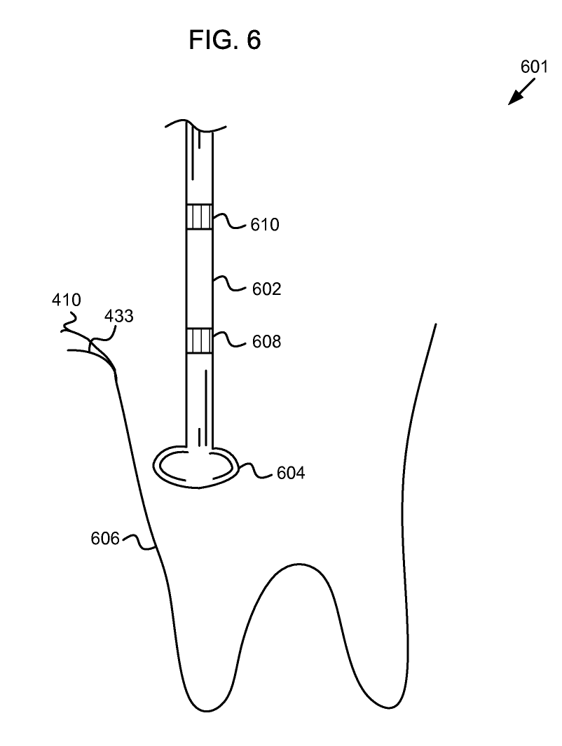

For example a Plaster of Paris (POP) solution may include an anti-inflammatory/antibiotic solute. Alternatively, one or more conventional POP preparations may be used as sealer materials. The practitioner next schedules an appointment with the patent, and, in step 306, performs atraumatic extraction of the natural tooth and root to maintain the boney socket intact. Optionally, a practitioner may specify a “tight” or “loose” implant, depending on his or her preferences with respect to atraumatic extraction technique and or exposure of the medullary bone in step 308. Referring to FIG. 2 and simplified partial cross section of FIG. 4, the bone structure 206, 404 typically includes a relatively porous and/or vascular portion 408 referred to as medullary bone. A layer of cortical bone 406, which may be referred to as dense socket bone, typically covers the surface of the medullary bone. Cortical bone 406 typically does not include vasculature and does not graft to an implant well. Rather, cortical bone 406 may tend to remodel to form bone that undergoes osseointegration into the implant. Step 308 includes removing a layer of cortical bone 406 from the surface of the medullary bone 408. FIG. 6 illustrates a tool for removing cortical bone.

Referring back to FIG. 3, the process 301 proceeds to step 310 where a sealer may be applied to the periphery of the implant. A sealer may include a matrix such as Plaster of Paris (POP) and/or hydroxyapatite with one or more anti-inflammatory and/or antibiotic solutes. Alternatively, one or more conventional POP preparations may be used. The sealer may immobilize the implant for a period of time sufficient for bone to graft to the implant. The sealer may also act as a bone graft material to fill voids and boney defects created by trauma and/or disease. The sealer may provide analgesic functions and/or pain relief.

An antibiotic/anti-inflammatory sealer may be provided, for example referring to FIG. 4, interstitially between the implant 402 and the bone 404. The sealer may be applied as a coating over and between features 420, 424. Because tooth extractions typically create a strong inflammatory response, anti-inflammatory medications may be especially desirable to avoid patient discomfort and perception that the implant is causing pain. Accordingly, a dressing may include analgesic and/or topical pain medications.

Proceeding to step 312, the implant is seated into the root socket. The implant may be seated in step 312 according to a variety of approaches. As may be seen in FIG. 4, a collar 414 of cortical bone may typically be tighter than the root region 416 below the collar 414. Typically, the implant is mechanically forced past the collar 414. According to an embodiment, the implant may be physically pushed into position by the practitioner, for example using a finger screw. According to another embodiment, a bite surface may be provided and the patient may be instructed to bite down to seat the implant. According to another embodiment, the implant may be tapped into position using a mallet, such as by tapping on the top surface of the finger screw.

Proceeding to step 314, a protective cap or an abutment may be placed or screwed into the top of the implant. The protective cap may have a low profile configured to avoid pressure, such as from tongue pressure, while bone grafts to the implant. According to an embodiment, a single piece implant may be placed. For instance, a small tooth such as a mandibular anterior tooth where the size restriction may be too small for a convenient use of a threaded screw, the implant may include an integral abutment. Steps 306 through 314 are typically performed during a single appointment while the patient is numb.

Step 316 may occur over an extended period. Optionally, a patient may switch providers for the remainder of the process 301. Medullary bone grows toward and along the surfaces 420 (FIG. 4) of the implant and the implant becomes permanently connected to the bone. Cortical bone may remodel to allow penetration of the features 424. Typically, bone will not grow across a gap greater than about 1 millimeter. Hence a good fit is important to ensure a positive outcome of the implant. Inclusion of a sealer matrix may support bone growth across a somewhat larger gap and/or with a somewhat more positive outcome. After the healing period of step 316, the patient is again scheduled for an appointment for execution of steps 318 through 324.

Steps 318 and 320 may be omitted for cases where the abutment was assembled during step 314 in lieu of a cap and/or in cases where the implant includes an integral abutment. In step 318, the practitioner removes the protective cap and optionally cleans the top surface of the implant. In step 320, the abutment is assembled to the implant. The abutment may fit into or onto a registration feature that sets the lateral location and rotation of the abutment. The height of the abutment is typically set by the top surface of the implant. For example, the registration feature may include a hexagonal hole or pedestal formed in or on the top surface of the implant. According to another embodiment, the registration feature may include a plurality of overlapping cylindrical holes. A mounting screw typically fixes the abutment to the implant. The abutment 440, registration feature 442, and mounting screw 448 are shown diagrammatically in FIG. 4.

Returning to FIG. 3, the process proceeds to step 322, where a crown impression is made according to conventional methods. A temporary crown may be provided in step 324. A permanent crown is ordered and received in step 326. Then, during a crown fitting appointment, the permanent crown 452 is affixed to the implant in step 328.

FIG. 4 is a simplified partial side sectional view of an assembled dental implant system 401 after implantation, according to an embodiment. The dental implant system 401 includes an implant 402 formed as an organically shaped root replacement, for example from titanium 6-4 alloy (Ti6Al4V medical grade). The implant 402 is fitted to a root socket 412 in a bone 404 including a cortical layer 406 over a medullary bone region 408. The crest of the bone 404 may typically be covered with approximately 3 millimeters of gum tissue 410. The root socket 412 may be formed by a practitioner via atraumatic extraction of a tooth.

The root socket 412 includes a cortical collar 414 of cortical bone 406 with overlying soft tissue removed. Following atraumatic extraction, the practitioner may typically remove the cortical bone layer in regions 416 below the cortical collar 414 to form an exposed medullary surface 416. The medullary bone surface 416 typically includes vasculature to support significant bone growth and resultant osseointegration of the implant 402.

The implant 402 includes a coarse scale surface region 418 including a plurality of retention features 420 having, according to an embodiment, a typical feature size of about 0.10 millimeter to 1 millimeter configured to mechanically anchor to the exposed medullary surface 416 and to provide an increased surface area selected to maximize osseointegration. Typically, the surfaces 418, 424 of the implant 402 are shaped to correspond to the surface of the root socket 412 and the exposed medullary surface 416 with no more than about 1 millimeter clearance. Leaving a gap greater than about 1 millimeter may disadvantageously allow soft tissue growth between the exposed medullary surface 416 and the coarse scale surface region 418 and/or be too large a gap for the bone medullary tissue 408 to bridge. Soft tissue growth into a large gap may prevent bone growth into the plurality of retention features 420. According to another embodiment, the retention features 420 may have a typical size of 0.2 millimeter to 1 millimeter.

The implant 402 includes a fine scale surface region 422 including a plurality of fine scale features 424 which, according to an embodiment, have a typical feature size of about 20 to 100 micrometers linear dimension in an area corresponding to the cortical collar 414. The fine scale surface region 422 including the plurality of fine scale features 424 is configured to provide a stable surface for contact with the cortical collar 414. The fine scale features 424 reduce or prevent bone dieback after implantation, a problem that may be seen with other surfaces such as a smoother surface or a rougher surface. Bone dieback causes the crested region of the bone 404 to recede relative to its natural level. Dieback of the crested bone region may lead to receding gum tissue 410 and corresponding objectionable aesthetics. According to another embodiment, the fine scale features 424 may have a typical size of 20 to 50 micrometers.

Selection of specific sizes for the coarse scale features 420 and fine scale features 424 may depend on practitioner preferences, location of the implant 402 in the patient's mouth, and patient information such as age. According to an embodiment, the sizes are selected such that the coarse scale features 420 are two times or greater in size than the fine scale features 424. According to another embodiment, the coarse scale features are five times or greater in size than the fine scale features.

Above the fine scale surface region 422, the implant 402 includes a tissue collar 430 that is smooth and optionally polished. The smooth surface of the tissue collar 430 is selected for compatibility with gum tissue 410 and allows gum growth along and in contact with the tissue collar 430. Optionally, the tissue collar 430 departs from the general axis of the implant 402 at an angle from a lower margin 432 and extends toward the center of the implant to a junction 434. The implant may include a flat top surface 436 extending to the junction 434 encircling the implant 402.

On its lower end, the tissue collar 430 ends at a lower margin 432. The tissue collar lower margin 432 configured to be installed substantially even with the upper surface the crested bone 404. According to an embodiment, the tissue collar lower margin 432 and the lower edge of the tissue collar surface varies in vertical position as it organically follows the particular anatomy around the root socket 412.

The upper end of the tissue collar 430 ends at a tissue collar edge 434 that forms an angle with an upper surface 436 of the implant 402. The upper tissue collar edge 434 may be arranged at a height configured to maintain a substantially flat surface 436. Alternatively, the top surface of the implant 436 may include a surface pattern such as radiating or other peaks and valleys, and the upper tissue collar edge 434 may be arranged to follow the contour of the top 436 of the implant 402. Alternatively, the upper tissue collar edge 434 may follow a path having about the vertical amplitude or a fraction of the vertical amplitude of the lower tissue collar edge 432 and the crested portion of the bone 404.

Accordingly, the angle formed by the tissue collar 430 may vary as a function of rotational location relative to the implant 402 and the anatomy 404, 406, 410 of the patient; or the angle may be substantially constant.

If the tissue collar lower margin 432 does not approximately follow the crested surface of the bone 404, it may be preferable for the edge 432 to be located to place a portion of the edge 432 below the top of the crested surface of the bone 404, such that gum tissue 410 is encouraged to grow to meet substantially the entire periphery of the implant 402 and the tissue collar 430. For example, it may be disadvantageous for a portion of the fine scale surface region 422 to contact gum tissue, because the contact point could be a point of irritation and/or recession.

The tissue collar 430 may extend to place the tissue collar upper edge 434 between about 0.25 millimeters and 2.0 millimeters above the top of the crested area of the bone 404. According to an embodiment, for example in the case of a non-flat top implant surface 436, the tissue collar edge 434 may be placed to be about 0.5 millimeters above the top of the bone 404 crest.

The implant system 401 includes an abutment 440 configured to couple to the implant 402. According to an embodiment, the tissue collar 430 may alternatively be formed as a polished surface on the abutment 440. The abutment 440 may adjoin the implant at the tissue collar lower edge 432. According to an embodiment, the abutment 440 may be formed integrally with the implant 402. The abutment 440 may have a surface corresponding to and configured to register to the top 436 and to a registration feature 442. The registration feature is typically configured to locate the abutment 440 at a constant translation and rotation, while the top 436 is typically configured to locate the abutment 440 at a constant height relative to the implant 402. The abutment 440 may be held flush with the top 436 and registration feature 442 by a mounting screw 448. The abutment 440 and the mounting screw 448 may be formed from a titanium 6-4 alloy (Ti6Al4V medical grade), stainless steel, or cobalt chromium, for example. Optionally, the screw thread surfaces of the tapped hole 446 or of the screw 448 may be treated to stabilize and hold tight the screw 448. Optionally, for example in temporary installations, the screw thread surfaces of the tapped hole 446 or of the screw 448 may be treated with an anti-seize material.

The abutment 440 may include a smooth lower surface 438 treated to promote gum growth and non-adhesion similarly to the surface of the tissue collar 430. The intersection of the lower surface 438 of the abutment 440 and the upper edge 434 of the tissue collar 430 may form an angle. For example, the angle may be configured to provide a space for soft tissue growth, such growth in turn providing a seal around the implant. Alternatively, the intersection of the lower surface 438 of the abutment 440 and the upper edge 434 of the tissue collar 430 may form arcs having coincident radii, may be formed to form a substantially continuous conical or cylindrical surface, or may adjoin in other arrangements.

The lower surface 438 of the abutment 440 may extend to an outer abutment edge 444. The abutment 440 may transition to a standard crown margin at and above the outer edge 444. For example, the abutment 440 may be formed with a chamfer margin, a butt margin, or other margin selected for proper crown placement. A crown 452 may be affixed to the abutment 440.

The depiction of FIG. 4 may correspond to various times. For example the bone socket 412 is illustrated as an exposed medullary surface 416 below a tissue collar corresponding to a time of implant 402 insertion. The abutment 440, if not integral, may typically be attached at a later time after at least partial osseointegration, at which time the edges of the retention features 420 of the coarse scale region 418 would coincide with growth of the bone tissue 404 (for example as woven bone). Alternatively, as described as an embodiment of the process of FIG. 3, the abutment may be placed immediately after the implant is seated. The crown 452 is typically placed at a later time after the abutment is securely placed.

The implant top surface 436 may be flat and substantially horizontal relative to the axis of the implant 402. According to another embodiment, the anatomy of the natural root that is replaced by the implant 402 may indicate that the implant top surface 436 is set at an angle to the axis of the implant 402. An abutment 440 may be registered to the implant 402 and the implant top surface 436 using an abutment registration feature 442. The abutment registration feature 442 may include a recess into the abutment top surface 436, and/or may include a protrusion above the abutment top surface 436. The shape of the abutment registration feature 442 is selected to prevent rotation and lateral movement between the implant 402 and the abutment 440. For example, the abutment registration feature 442 may include a hexagonal shape or overlapping bores formed in the implant top surface 436. The abutment registration feature 442 and the corresponding feature in the abutment 440 may be formed such that the abutment 440 penetrates less than the entire depth into the registration feature 442 in the implant 402, so as to leave a small clearance at the bottom of the registration feature 442 such that the abutment 440 is guaranteed to be vertically registered by the implant top surface 436 against the abutment 440 bottom surface.

An abutment mounting hole 445 is placed to align with a drilled and tapped hole 446 in the implant 402. An abutment mounting screw 448 is driven through the abutment mounting hole 445 and into the tapped hole 446 in the implant 402 to secure the abutment 440 to the implant 402. A countersink hole 450 is configured to accept the head of the abutment screw 448 such that the top surface of the head of the abutment screw 448 is at or below the top surface 449 of the abutment 440.

Typically the implant 402, the abutment 440, and the abutment screw 448 may be formed from titanium 6-4 alloy (Ti6Al4V medical grade). Preferably, the abutment screw 448 has a diameter and length to ensure sufficient strength to secure the abutment 440 to the implant 402 against compressive and lateral loads placed on the abutment 440.

During placement of the implant 402, the abutment 440 is typically not attached to the implant 402. Instead, a finger screw (not shown) is inserted into the tapped hole 446 to provide a handling surface that protrudes above the implant top surface 436 and surrounding tissues 410. After removal of the cortical layer 406 to expose the medullary surface 416 below the cortical collar 414, the implant 402 is typically force-fit into the root socket 412. The force with which the implant 402 is inserted into the root socket 412 is typically sufficient to force the retention features 420 of the coarse scale surface region 418 past the cortical collar 414 and embed the tips of the retention features 420 into the medullary bone 408. The implant seating force may be provided by temporarily placing or affixing a bite surface (not shown) to the top of the implant 402 and asking the patient to bite down on the bite surface. Alternatively, an impact surface (which may be the same as the bite surface and/or the finger screw, not shown) may be affixed to or placed on the implant 402, and the implant 402 may be tapped into place with a small mallet. Following placement, a cap (not shown) may be screwed into the tapped hole 446 and remain in place for 8 to 16 weeks while sufficient osseointegration of the implant 402 occurs. Typically, the lower surface 438 of a cap is screwed to be tight against the top surface 436 of the implant 402.

A sealer may be applied prior to implant placement over and/or adjacent to the implant 402, and particularly into the region below the lower tissue collar surface and/or adjacent to the fine scale surface region 422 to temporarily fix the implant 402 relative to the bone surfaces 414, 416. A fixed position of the implant 402 in the root socket 412 is important to osseointegration. The cap (not shown) over the implant 402 may be a low relief structure configured to minimize lateral loads on the implant 402 during osseointegration and prevent accumulation of food debris in recesses below the gum line 410 and tapped hole 446. Optionally, the cap may include a lower surface selected to be coincident with the tissue collar 430 and/or the lower surface 438 of the abutment 440 and/or a crown 452. Providing a cap having a profile substantially the same as the eventual appliance may aid in promoting gum growth and reduce problems during healing and osseointegration.

After a few weeks, the sealer dissolves and the interference fit between the retention features 420 and the medullary surface 416 and new bone growth fixes the implant in place. After sufficient stability is achieved or a time period allowed for osseointegration has elapsed, the cap (not shown) may be removed and the abutment 440 affixed to the implant 402. A crown impression is taken and a temporary crown affixed. After receipt of the permanent crown 452, the crown 452 may be installed over the implant 402 and the abutment 440. The lower edge of the crown 452 may be placed at locations coincident with the lower surface 438 and/or the outer edge 444 of the abutment 440 as shown. The gum tissue 410 may cover the lower edge of the crown 452 and prevent objectionable discoloration caused by the implant 402 and/or abutment 440 showing through a translucent crown 452 material.

FIG. 5 is a block diagram of a system including a data processing system 502 configured to produce a data model for making a custom dental implant, according to an embodiment. An X-ray imager 506 such as a computed tomography (CT) imager may capture an image of a root volume of a patient 504. Optionally, a visible imager 508 may capture a visible image of remaining tooth structure and optionally neighboring teeth and soft tissue. According to an embodiment, a visible image captured by the visible imager 508 may be registered to the root volume image captured by the X-ray imager 506. For example, the visible and root volume images may be captured using a bore-sight mechanism such as a beam splitter 510. If a wavelength-selective mirror 510 is used, the images may be captured substantially simultaneously.

Images captured by the X-ray imager 506 and optionally the visible imager 508 may be received by the data processing system 502 via one or more data interfaces 512, 514. The received image(s) may be saved or cached in an image memory 515. A core design module 516 may read the images from memory and perform image processing to define the envelope of a core model substantially corresponding to the physical extent of the root of the tooth. Since some inaccuracy may typically be inherent in imaging mechanisms 506, 508, the degree to which the core model departs from the actual physical extent may typically include at least the inaccuracy in imaging. Other effects such as Nyquist-related imprecision, aliasing, etc. in edge-finding may also contribute inaccuracy to images read from the image memory 515. Additionally, patient anatomy and/or physiology may further contribute inaccuracy to the core envelope, such as if the PDL is missing or thin. Finally, smoothing, anti-aliasing, and/or edge-finding algorithm limitations in the image processor may contribute to inaccuracy in the core model relative to the actual tooth root or root socket.

Optionally, the core design module 516 may be further configured to receive patient information. As described elsewhere, patent information may be used as input to the core design function. For example, patient age, sex and/or disease history may be used to select an edge-finding algorithm or a surface location bias based on typical PDL thickness.

The data processing system 502 may further include a data conversion module (not shown) configured to convert one or more input data formats to another data format. For example, the data conversion module may be integrated into the data interface(s) 512, 514 and/or the core design module 516; or the data conversion module may include separate circuitry or software module(s). For example, a data conversion module may convert incoming DICOM data to IGES, STL, or another data format adapted for convenient CAD manipulation. For example, conversion from DICOM to IGES data may occur inherently, such as during core design.

The core design is received by a CAD module 518. The CAD module 518 (automatically, manually, or a combination thereof) is configured to add features and/or otherwise modify the shape of the core model. For example, for embodiments where the core design module 516 is not configured to provide Nyquist compensation, account for patient anatomy and/or physiology, provide smoothing, provide anti-aliasing, and/or otherwise modify the edge-finding algorithm, the CAD module may be configured to provide corresponding functionality. For example, the CAD module may be configured to move surfaces toward or away from the centroid of the core design based upon predetermined adjustment algorithms based on patient 504 information, X-ray imager 506 characteristics, image artifact data, or one or more visible image vs. X-ray image relationships. Such movement of surfaces may be referred to as making core adjustments.

The CAD module 518 is configured to add non-natural morphological features to the core model. For example, referring to FIG. 4, the CAD module may add one or more of a coarse scale surface region 418 including a plurality of retention features 420, a fine scale surface region 422 including a plurality of fine scale features 424, a fixture element 428 including a tissue collar 430, a tissue collar edge 434, an upper fixture surface 436, and an implant top surface 436. The CAD module 518 may further select an abutment 440, an abutment registration feature 442 and an abutment mounting hole 445.

According to an embodiment, the CAD module 518 may select features from an implant library 520 and/or may algorithmically generate feature shapes. The implant model defined by the CAD module 518 may then be exported through an output data interface 524 to an implant fabricator 526. The selected abutment shape may optionally be custom fabricated, or may be selected from an inventory of stock shapes. Because the shape of the abutment 440 is typically less critical to positive outcome than the shape of the implant 402, according to embodiments, a relatively modest number of abutment shapes may provide sufficient customization, thus allowing the abutments to be manufactured separately from the implant 402.

The core design module 516 and/or the CAD module 518 may include a user interface 522 configured to display images, surfaces, wireframes, etc. The user interface may further include a keyboard and computer pointing device configured to control the core design module 516, manage the image memory 515 and the implant library 520 (described below) control the CAD module 518, manage data conversion such as via a data conversion module (not shown), and/or manage receipt and transmission of data respectively via the data interface(s) 512, 514 and the output data interface 524. For example the data processing system 502 may include a computer running an operating system, and the operating system may manage data transmission from user data input and user data output hardware.

Optionally, the core design module 516 and/or the CAD module 518 may be configured to adjust the position of one or more model surfaces responsive to a practitioner request for a loose or tight fit of the dental implant.

FIG. 6 is a diagram illustrating a tool 601 configured to remove a section of cortical bone layer from a root socket 606, according to an embodiment. As described above in reference to FIG. 4, following atraumatic extraction, the practitioner may typically remove the cortical bone layer in regions below the cortical collar 414 to form an exposed medullary surface 416. Optionally a kit provided to a practitioner may include the tool 601 including a shaft 602 configured to fit into a conventional dentist's drill and a burr 604 such as a diamond burr. A pair of marks 608, 610 may be formed on the shaft 602 at distances from the burr respectively corresponding to the cortical collar 414 height and the maximum depth of the course features 420. The practitioner may align the mark 608 with the top of the soft tissue 410 or the top of the bone 433 and grind the periphery of the socket 606 at a corresponding depth to define the lower edge of the cortical collar 414. Of course, the position of the mark 608 along the shaft 602 may be determined according to the height of the fine scale surface region 422 included in the CAD model of the implant. The practitioner may grind the periphery of the socket 606 to a depth corresponding to the mark 610. Optionally, the mark 610 may be omitted and the practitioner may grind the periphery of the socket 606 to a depth determined by eye. Optionally, for implants having a fine scale surface region 422 that is formed to a variable depth relative to the neighboring bone top 433, a second or third mark (not shown) formed between the burr 604 and the mark 608 may correspond to a shallower portion of the fine scale surface region 422.

According to an embodiment, the border between the fine scale surface region 422 and the coarse scale surface region 418 of the implant 402 may be designed to remain a relatively constant distance from the top surface of the gum 410, the top of the bone 433, or another index surface (not shown). In such a case, a single mark 608 may be sufficient to guide the practitioner to define the lower edge of the cortical collar 414.

While various aspects and embodiments have been disclosed herein, other aspects and embodiments are contemplated. The various aspects and embodiments disclosed herein are for purposes of illustration and are not intended to be limiting, with the true scope and spirit being indicated by the following claims.

What is claimed is:

1. A method for producing an electronic model for a dental implant, comprising:
acquiring an image of at least a volume corresponding to a root of a tooth using illumination having a wavelength shorter than the visible portion of the electromagnetic spectrum; and
transmitting data corresponding to the acquired image to a dental implant production facility.

2. The method for producing an electronic model for a dental implant of claim 1, wherein acquiring an image includes performing tomography.

3. The method for producing an electronic model for a dental implant of claim 2, wherein acquiring an image includes performing computed axial tomography or cone beam computed axial tomography.

4. The method for producing an electronic model for a dental implant of claim 1, wherein the image includes an image of a root of a tooth.

5. The method for producing an electronic model for a dental implant of claim 1, wherein the image includes an image of an impression substantially filling a volume previously occupied by a root of a tooth.

6. The method for producing an electronic model for a dental implant of claim 1, further comprising:
acquiring a visible image including at least an exposed volume corresponding to the tooth; and
wherein transmitting data corresponding to the acquired image includes transmitting data corresponding to the acquired visible image.

7. The method for producing an electronic model for a dental implant of claim 6, wherein acquiring a visible image includes acquiring a visible image of the tooth and at least portions of neighboring teeth.

8. The method for producing an electronic model for a dental implant of claim 6, wherein acquiring a visible image includes acquiring a visible image of an occlusion corresponding to the tooth.

9. The method for producing an electronic model for a dental implant of claim 6, wherein acquiring a visible image includes acquiring a visible image registered to the image using illumination provided by radiation having a wavelength shorter than the visible portion of the electromagnetic spectrum.

10. The method for producing an electronic model for a dental implant of claim 6, wherein acquiring a visible image includes acquiring a visible image bore-sighted to the image using illumination provided by radiation having a wavelength shorter than the visible portion of the electromagnetic spectrum.

11. The method for producing an electronic model for a dental implant of claim 1, wherein transmitting the data to a dental implant production facility includes transmitting the data to an external facility.

12. The method for producing an electronic model for a dental implant of claim 1, wherein transmitting the data to a dental implant production facility includes transmitting the data to an in-premises dental implant production machine.

13. The method for producing an electronic model for a dental implant of claim 1, wherein acquiring an image includes acquiring an in situ image.

14. The method for producing an electronic model for a dental implant of claim 1, wherein acquiring an image includes acquiring an in vivo image.

15. The method for producing an electronic model for a dental implant of claim 1, wherein the image includes a voxel image.

16. The method for producing an electronic model for a dental implant of claim 1, wherein the data corresponds to at least one of computed tomography digital data; DICOM data; an IGES file; a tool path; a core design; and a dental implant model including non-morphological features.

17. The method for producing an electronic model for a dental implant of claim 1, further comprising:
before or after transmitting the data corresponding to the acquired image, formatting the data to a format corresponding to instructions for a dental implant fabrication machine.

18. The method for producing an electronic model for a dental implant of claim 1, further comprising:
receiving the data; and
driving a dental implant fabrication machine to produce a dental implant corresponding to the image.

19. The method for producing an electronic model for a dental implant of claim 1, further comprising:
before or after transmitting the data, modifying the data such that the data also corresponds to one or more shapes not included in the acquired image.

20. The method for producing an electronic model for a dental implant of claim 19, wherein the data is modified to include at least one feature configured to achieve one or more of compensation for image artifacts, a dental implant with increased surface area for bone integration, easier placement of a dental implant, more accurate placement of a dental implant, a dental implant with greater stability, replacement of displaced soft tissue, a dental implant including an abutment, a dental implant with a tissue collar, or a dental implant with an abutment interface.

21. The method for producing an electronic model for a dental implant of claim 1, wherein the illumination having a wavelength shorter than the visible portion of the electromagnetic spectrum includes X-ray illumination.

22. An apparatus for producing an electronic model of a dental implant, comprising:
at least one data interface configured to receive a computed tomography file from a computed tomography apparatus, wherein the computed tomography file includes an acquired in vivo image of at least a volume corresponding to a root of a tooth;
a core design module configured to determine, from at least the computed tomography file, a core design corresponding substantially to at least a portion of the natural shape of the root of the tooth;
a computer-aided design module configured to receive the core design and modify the core design to produce an implant design that differs in shape from the input file, and output a fabrication model file corresponding to the implant design.

23. The apparatus for producing an electronic model of a dental implant of claim 22, further comprising a computer; and
wherein the core design module and the computer-aided design module include computer-executable instructions configured to be executed by the computer.

24. The apparatus for producing an electronic model of a dental implant of claim 22, wherein the at least one data interface includes at least two data interfaces configured to respectively receive the computed tomography file and output the fabrication model file.

24. The apparatus for producing an electronic model of a dental implant of claim 22, further comprising:
an implant library including shapes or converters configured to modify data corresponding to the received image.

25. A dental implant, comprising:
a core shape corresponding at least partly to the morphology of a natural root of a particular tooth; and
a fixture element including an abutment registration feature configured to fix the position of an abutment relative to the fixture element.

26. The dental implant of claim 25, further comprising:
a coarse scale surface region across a portion of the surface of the core shape, the coarse scale surface region including a plurality of retention features configured to anchor the dental implant to a particular location relative to a patient's medullary bone during osseointegration.

27. The dental implant of claim 26, wherein the plurality of retention features include at least one of grooves, rings, notches, chevrons, voxel patterns, a roughened surface, or a rough surface inherent in a fabrication technology.

28. The dental implant of claim 25, wherein the core shape is determined according to at least one of anti-aliasing, pixelation smoothing, ray scatter compensation, PDL thickness compensation; root truncation; abscess compensation; patent information compensation; or practitioner tightness preference.

29. The dental implant of claim 25, wherein the abutment registration feature includes at least on of a non-rotationally symmetric hole, a non-rotationally symmetric protrusion, a plurality of overlapping cylindrical holes, a hexagonal hole, or a hexagonal protrusion.

30. The dental implant of claim 25, formed from titanium 6-4.

31. The dental implant of claim 25, further comprising:
a fine scale surface region across a portion of the surface of the core shape, the fine scale surface region including a plurality fine scale features configured to provide a stable interface with a cortical collar in a particular root socket.

32. The dental implant of claim 31, wherein the scale of the plurality of fine scale features configured to prevent bone dieback following osseointegration.

33. The dental implant of claim 25, wherein the fixture element includes a tissue collar configured to be compatible with soft tissue in the mouth of a patient.

34. The dental implant of claim 25, further comprising an abutment configured for attachment to the fixture element.

35. The dental implant of claim 25, further comprising an abutment selected from a plurality of stock abutment shapes.

36. The dental implant of claim 25, further comprising an integral abutment.

37. A method for fabricating a dental implant, comprising:
receiving a data file corresponding to at least partly to the morphology of a natural root of a particular tooth; and
forming a dental implant from titanium 6-4 in a shape corresponding to the data file.

38. The method for fabricating a dental implant of claim 37, wherein the data file and the dental implant include a fixture element including an abutment registration feature configured to fix the position of an abutment relative to the fixture element.

39. The method for fabricating a dental implant of claim 38, wherein the abutment registration feature includes at least on of a non-rotationally symmetric hole, a non-rotationally symmetric protrusion, a plurality of overlapping cylindrical holes, a hexagonal hole, or a hexagonal protrusion.

40. The method for fabricating a dental implant of claim 38, wherein the fixture element includes a tissue collar configured to be compatible with soft tissue in the mouth of a patient.

41. The method for fabricating a dental implant of claim 37, further comprising forming a coarse scale surface region across a portion of the surface of a core shape, the coarse scale surface region including a plurality of retention features configured to anchor the dental implant to a particular location relative to a patient's medullary bone during osseointegration.

42. The method for fabricating a dental implant of claim 41, wherein the plurality of retention features include at least one of grooves, rings, notches, chevrons, voxel patterns, a roughened surface, or a rough surface inherent in the fabrication technology.

43. The method for fabricating a dental implant of claim 37, further comprising forming a fine scale surface region across a portion of the surface of a core shape, the fine scale surface region including a plurality fine scale features configured to provide a stable interface with a cortical collar in a particular root socket.

44. The method for fabricating a dental implant of claim 37, wherein the data file and the dental implant include a fixture element including an abutment registration feature configured to fix the position of an abutment relative to the fixture element; and further comprising:
providing an abutment configured for attachment to the fixture element.

45. The method for fabricating a dental implant of claim 44, wherein providing the abutment includes selecting the abutment from a plurality of stock abutment shapes.

44. The method for fabricating a dental implant of claim 37, wherein the data file and the dental implant include an integral abutment.

45. A kit for equipping a practitioner to insert a custom dental implant, comprising:
a dental implant having a core shape corresponding at least partly to the morphology of a natural root of a particular tooth; and
a calibrated tool for removing cortical bone from the particular socket of the particular natural root and retaining a cortical collar corresponding to a fine scale feature region formed on the surface of the dental implant.

46. The kit for equipping a practitioner to insert a custom dental implant of claim 45, further comprising:
an abutment configured to couple to a registration feature formed on the dental implant; and
an abutment screw configured to secure the abutment to the dental implant.

47. The kit for equipping a practitioner to insert a custom dental implant of claim 46, wherein the abutment is selected from a plurality of stock abutment shapes.

48. The kit for equipping a practitioner to insert a custom dental implant of claim 45, further comprising:
a finger screw configured to temporarily couple to the dental implant during implant seating to facilitate handling by the practitioner; and
a protective cap configured to temporarily couple to the dental implant during osseointegration.

49. The kit for equipping a practitioner to insert a custom dental implant of claim 45, further comprising:
documentation physically associated with the dental implant, the documentation including patient identification and tooth or implantation site identification.

50. The kit for equipping a practitioner to insert a custom dental implant of claim 49, wherein the documentation further comprises:
at least one X-ray image of the root or an impression material corresponding to the implantation site.

51. The kit for equipping a practitioner to insert a custom dental implant of claim 50, wherein the at least one X-ray image further comprises a superimposed indication of a detected edge of the root or the impression material.

52. The kit for equipping a practitioner to insert a custom dental implant of claim 45, further comprising:
at least one implant model configured to provide an indication of fitment of the dental implant into a prepared socket.

53. The kit for equipping a practitioner to insert a custom dental implant of claim 52, wherein the at least one implant model includes a feature configured to indicate clearance between the implant model and the prepared socket.

54. The kit for equipping a practitioner to insert a custom dental implant of claim 52, further comprising:
an indicator material configured to indicate clearance between the implant model and the prepared socket.

55. The kit for equipping a practitioner to insert a custom dental implant of claim 45, further comprising:
a bite surface configured to provide for an occlusion of the patient to seat the implant into a prepared socket upon application of bite pressure.
